(19) United States
(12) Patent Application Publication
(10) Pub. No.: US 2026/0159434 A1
(43) Pub. Date: Jun. 11, 2026

(54) OVERFLOW BRICKS, APPARATUS, AND METHODS FOR STABLY PRODUCING SUBSTRATE GLASS

(71) Applicant: CAIHONG DISPLAY DEVICES CO., LTD., Xianyang (CN)

(72) Inventors: Weidong HU, Xianyang (CN); Zhijun ZHANG, Xianyang (CN); Jian XU, Xianyang (CN); Longjiang ZHAO, Xianyang (CN); Yongjing REN, Xianyang (CN); Ting LUO, Xianyang (CN)

(73) Assignee: CAIHONG DISPLAY DEVICES CO., LTD., Xianyang (CN)

(21) Appl. No.: 19/404,036

(22) Filed: Dec. 1, 2025

Related U.S. Application Data
(63) Continuation-in-part of application No. PCT/CN2025/113522, filed on Aug. 8, 2025.

(30) Foreign Application Priority Data
Dec. 5, 2024 (CN) 202411781170.8

(51) Int. Cl. C03B 17/06

(52) U.S. Cl. CPC C03B 17/064

(57) ABSTRACT

The present disclosure discloses overflow bricks, apparatus, and methods for stably producing substrate glass, and belongs to the technical field of manufacturing liquid crystal substrate glass. The overflow brick provided in the present disclosure adopts a split arched overflow brick structure, thereby weakening the influence of the overflow brick's own gravity on the production stability. Meanwhile, each of the support clamping devices with the L-shaped structure is introduced to counteract the negative effects of the creep by applying the clamping force horizontally.

### CROSS-REFERENCE TO RELATED APPLICATIONS

This application is a continuation-in-part application of International Application No. PCT/CN 2025/113522, filed on Aug. 8, 2025, which claims priority to Chinese Patent Application No. 202411781170.8, filed on Dec. 5, 2024, the entire contents of each of which are hereby incorporated by reference.

### TECHNICAL FIELD

The present disclosure relates to the technical field of manufacturing liquid crystal substrate glass, and in particular, to overflow bricks, apparatus, and methods for stably producing substrate glass.

### BACKGROUND

In the technical field of manufacturing liquid crystal substrate glass (e.g., Thin-Film Transistor-Liquid Crystal Display (TFT-LCD), Plasma Display Panel (PDP), etc.), an overflow and draw-down process is widely adopted. The core of the overflow and draw-down process lies in supplying molten glass from a glass melting furnace to a fusion overflow and draw-down forming apparatus to complete the forming process. As a key technology in substrate glass production, the basic principle of the overflow and draw-down process is that the molten glass enters an overflow channel from a supply portion, and then flows downward along an overflow groove. A lower portion of the overflow groove is generally designed in a wedge shape, such that the molten glass flows down along two wedge-shaped surfaces, and finally converges at a bottom edge of the wedge shape to form a glass ribbon. The glass ribbon undergoes subsequent operations (e.g., annealing) to produce high-quality substrate glass. Compared with the float process and the slot draw process, the overflow and draw-down process can produce glass sheets having superior surface flatness and smoothness, and eliminate cumbersome operations of secondary forming.

An overflow brick, as a core component in the overflow and draw-down process, is configured to carry and guide the molten glass. The molten glass flows within the overflow brick and ultimately overflows from two sides of the overflow brick to form the continuous glass ribbon. The shape and dimensional accuracy of the overflow brick have a significant impact on thickness uniformity of the glass ribbon. If deformation or wear occurs in the overflow brick, the flow of the molten glass becomes uneven, thereby adversely affecting the thickness uniformity of the glass ribbon. However, in a high-temperature environment inside a muffle furnace, where the temperature reaches up to approximately 1300° C., prolonged high-temperature operation may cause the deformation of the overflow brick, thereby compromising the shape and dimensional accuracy of the overflow brick. One primary reason for this deformation lies in that the conventional overflow brick is supported and fixed at the two ends of the overflow brick. During the deformation process, a middle portion of the overflow brick is prone to sagging, causing a depression of a groove along the middle portion. Consequently, the overflow rate of the molten glass increases in the middle portion, leading to an increased thickness in the middle of the glass substrate. This non-uniform thickness can induce defects (e.g., warping, stress, etc.), thereby reducing the yield rate. Simultaneously, with the continuous development of high-generation substrate glass, quality requirements for the substrate glass have become increasingly stringent. Although the overflow and draw-down process has become the mainstream process in the industry due to its superior surface quality and the convenience without secondary processing, the continuous increase in glass size has necessitated a corresponding enlargement of the overflow brick, which is the core component. This, in turn, aggravates the problem of high-temperature creep of the overflow brick. The high-temperature creep not only directly disrupts the flow distribution of the molten glass, thereby impairing the thickness uniformity of the substrate glass, but in severe cases, can also substantially shorten the service life of the entire overflow apparatus.

Therefore, how to effectively solve the problem of the high-temperature creep of the overflow brick has become a technical challenge urgently requiring resolution. Accordingly, it is desired to provide overflow bricks, apparatus, and methods for stably producing the substrate glass, so as to overcome the deformation of the overflow brick caused by long-term operation in the high-temperature environment in the existing technology.

### SUMMARY

One or more embodiments of the present disclosure provide an overflow brick for stably producing substrate glass, comprising: an overflow brick body; and support clamping devices, wherein the overflow brick body includes a first brick body and a second brick body sequentially from top to bottom; the first brick body is provided with a concave overflow groove, an upper end surface of the concave overflow groove is an inclined surface, and the first brick body is configured to accommodate molten glass; the first brick body is fixedly connected to the second brick body; the second brick body has a V-shaped structure, and is configured to overflow and draw-down the molten glass; a fixed connection surface between the first brick body and the second brick body is an arched curved surface; each of the support clamping devices has an L-shaped structure; a horizontal section of each of the support clamping devices is provided with a recessed groove adapted to the V-shaped structure, and the horizontal section of the support clamping devices are symmetrically arranged at two ends of the second brick body; vertical section of the support clamping devices clamp two ends of the overflow brick body; and an end surface of each of the vertical section is higher than a highest horizontal cross-section of the arched curved surface and lower than an inner groove bottom surface of the concave overflow groove.

One or more embodiments of the present disclosure provide an overflow apparatus for stably producing substrate glass, comprising: the overflow brick for stably producing the substrate glass.

One or more embodiments of the present disclosure provide a method for stably producing substrate glass using the overflow brick for stably producing substrate glass, comprising: applying an acting force F to the overflow brick body; and controlling creep of the overflow brick by adjusting the acting force F.

### BRIEF DESCRIPTION OF THE DRAWINGS

The accompanying drawings are configured to provide a further understanding of the present disclosure and constitute a portion of the present disclosure. The exemplary embodiments of the present disclosure and the descriptions thereof are used to explain the present disclosure, and are not intended to limit the scope of the present disclosure.

FIG. 1 is a schematic diagram illustrating a structure of an overflow brick according to the prior art.

FIG. 2 is a cross-sectional view illustrating a structure of an overflow brick according to the prior art.

FIG. 3 is a schematic diagram illustrating a simplified force analysis of an overflow brick without creep according to the prior art.

FIG. 4 is a schematic diagram illustrating a simplified force analysis of an overflow brick with creep according to the prior art.

FIG. 5 is a schematic diagram illustrating a structure of an overflow brick according to some embodiments of the present disclosure.

FIG. 6 is a cross-sectional view illustrating a structure of an overflow brick according to some embodiments of the present disclosure.

FIG. 7 is a schematic diagram illustrating a simplified force analysis of an overflow brick according to some embodiments of the present disclosure.

In the drawings, 11 represents an inner groove bottom surface, 12 represents an overflow brick weir, 13 represents an original support clamping device, 111 represents a creeped inner groove bottom surface, 121 represents a creeped overflow brick weir, G represents gravity, g1 and g2 represent components of the gravity G, F represents an acting force, W represents a fulcrum span, H1 represents an arched height, H2 represents a distance from a highest point of a arched curved surface to the inner groove bottom surface of the concave overflow groove, f1 and f2 represent components of the acting force F, 21 represents a first brick body, 22 represents a second brick body, 23 represents a support clamping device, 24 represents a positioning pin, 25 represents a displacement sensor, 211 represents the arched curved surface, and 212 represents an connection surface.

### DETAILED DESCRIPTION

In order to more clearly illustrate the objectives, technical solutions, and advantages of the embodiments of the present disclosure, the following will introduce the drawings in the embodiments of the present disclosure to clearly and completely describe the technical solutions in the embodiments of the present disclosure. Obviously, the described embodiments are some embodiments of the present disclosure, but not all embodiments. Components of the embodiments of the present disclosure, which are generally described and illustrated in the drawings herein, may be arranged and designed in various different configurations.

Therefore, the following detailed description of the embodiments of the present disclosure provided in the accompanying drawings is not intended to limit the scope of the present disclosure, but merely represents the selected embodiments of the present disclosure. Based on the embodiments of the present disclosure, all other embodiments obtained by those of ordinary skill in the art without creative work shall fall within the scope of the present disclosure.

It should be noted that similar reference numerals and letters represent similar items in the following drawings. Therefore, once an item is defined in one drawing, it does not need to be further defined and explained in subsequent drawings.

In the description of the embodiments of the present disclosure, it should be noted that if orientations or positional relationships represented by terms (e.g., “upper,” “lower,” “horizontal,” “inner,” etc.) are based on orientations or positional relationships shown in the drawings, or orientations or positional relationships where the product of the invention is customarily placed during use, the terms are merely for convenience of describing the present disclosure and simplifying the description, and do not indicate or imply that the referred device or element must have a specific orientation or be constructed and operated in the specific orientation. Therefore, the terms are not intended to limit the scope of the present disclosure. In addition, terms (e.g., “first,” “second,” etc.) are merely used for distinguishing the description and cannot be understood as indicating or implying relative importance.

In addition, it should be further noted that unless otherwise explicitly specified and defined, terms (e.g., “setting,” “installation,” “connection,” “linking,” etc.) should be understood in a broad sense. For example, the connection may be a fixed connection, a detachable connection, or an integral connection. The connection may be a mechanical connection or an electrical connection. The connection may be a direct connection, an indirect connection through an intermediate medium, or an internal communication between two elements. Those of ordinary skill in the art may understand specific meanings of the above terms in the present disclosure according to specific situations.

The following provides a further detailed description of the present disclosure in combination with the accompanying drawings and specific embodiments, which is an explanation rather than a limitation of the present disclosure.

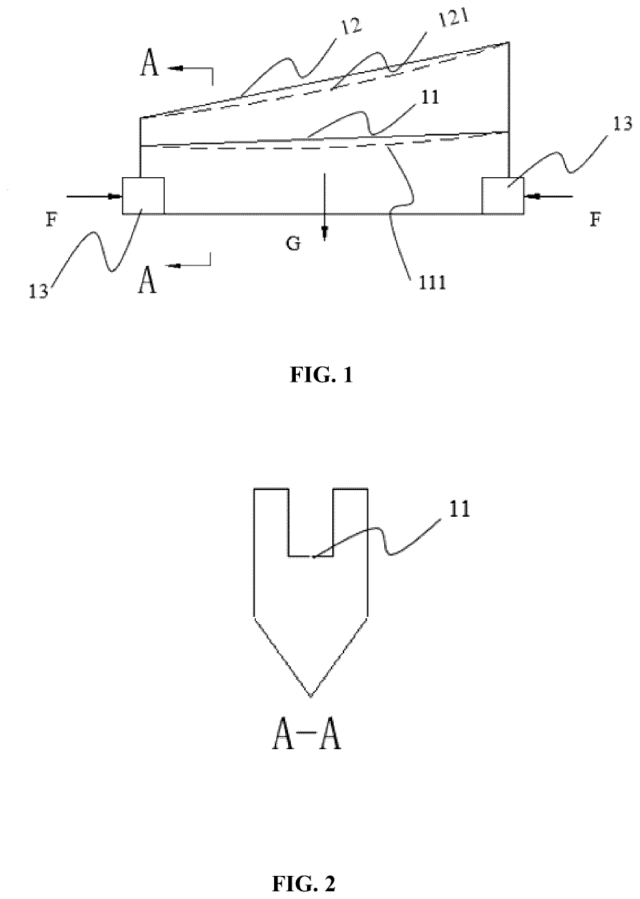

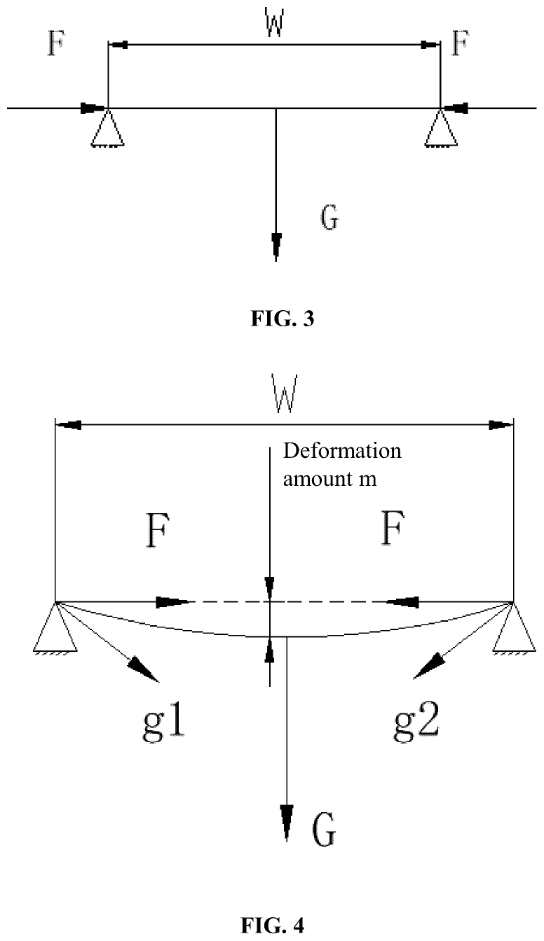

Referring to FIGS. 1 and 2, FIG. 1 is a schematic diagram illustrating a structure of an overflow brick according to the prior art. FIG. 2 is a cross-sectional view illustrating a structure of an overflow brick according to the prior art. As shown in FIGS. 1 and 2, an overflow brick body is vertically placed on original support clamping devices 13 at both ends. Referring to FIG. 3, FIG. 3 is a schematic diagram illustrating a simplified force analysis of an overflow brick without creep according to the prior art. As shown in FIG. 3, an acting force F is applied in a horizontal direction to clamp the overflow brick body, and a sum of gravity G of gravity of the overflow brick body and gravity of molten glass is applied in a vertical direction.

A creep amount is determined according to an equation Δ=\dot{ε}×W×t, where \dot{ε} represents a relative creep rate of the overflow brick, W represents a fulcrum span of the overflow brick, and t represents a designed service time. More descriptions may be found hereinafter. Referring to FIG. 4, FIG. 4 is a schematic diagram illustrating a simplified force analysis of an overflow brick with creep according to the prior art. As shown in FIG. 4, as time goes by, the creep amount increases, and an overflow brick weir 12 and an inner groove bottom surface 11 gradually bend and deform to positions of a creeped overflow brick weir 121 and a creeped inner groove bottom surface 111 in FIG. 1, respectively. At this time, the molten glass along the crept overflow brick weir 121 no longer overflows uniformly, and a trend of a glass plate being thicker in the middle and thinner on both sides becomes increasingly obvious. Under an action of the gravity G, a downward bending deformation as shown in FIG. 4 is generated. As the deformation amount m continuously increases, the clamped acting force F is increased to suppress an increase in the creep in conventional techniques. However, once the creep occurs, the increase in the acting force F would further aggravate the creep. Generally, for an overflow brick with a length of 2 meters (m) to 2.5 m (corresponding to G6-G7.5 products), the creep amount would exceed 15 millimeters (mm) after 2 to 3 years of production, and thickness uniformity cannot meet requirements, resulting in a replacement of the entire overflow apparatus, thereby seriously affecting production and enterprise benefits. The overflow brick of a high-generation (G8.5 and above) has a longer length and a larger span W, reaching 3 m to 3.5 m. According to a creep rate of the same material, the creep amount of the overflow apparatus of the structure exceeds 20 mm after 2 years, thereby seriously affecting the production.

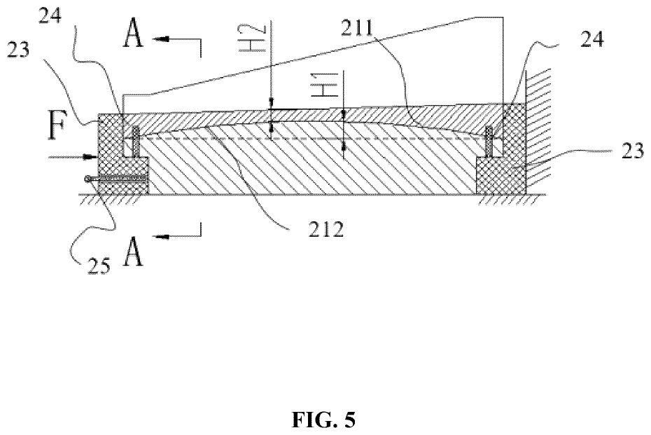

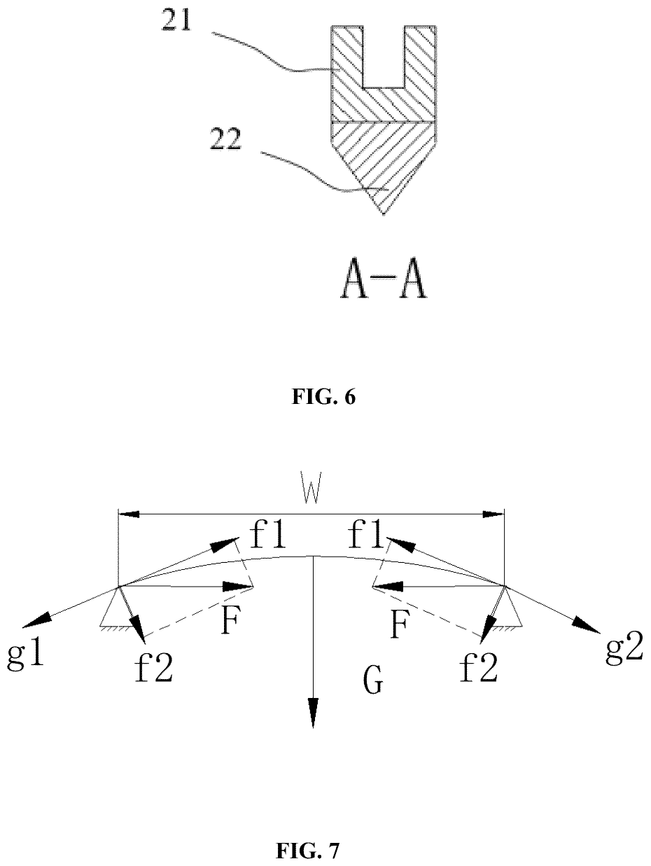

Referring to FIGS. 5 and 6, FIG. 5 is a schematic diagram illustrating a structure of an overflow brick according to some embodiments of the present disclosure. FIG. 6 is a cross-sectional view illustrating a structure of an overflow brick according to some embodiments of the present disclosure. According to the present disclosure, a first brick body 21 and a second brick body 22 of the overflow brick are separately processed, ensuring the same matching arched curved surface 211. An arched height H1 of the arched curved surface 211 is larger than the creep amount Δ (unit:Mm), and a distance H2 from the arched curved surface 211 to the inner groove bottom surface of the concave overflow groove is larger than 30 mm (minimum thickness for strength). Same positions at an upper portion and a lower portion of the overflow brick are provided with pin holes, and the pin holes are connected by positioning pins 24. After further assembly and processing, all connection surfaces 212 are smooth and flat.

Referring to FIG. 7, FIG. 7 is a schematic diagram illustrating a simplified force analysis of an overflow brick according to some embodiments of the present disclosure. As shown in FIG. 7, according to characteristics of an arch structure of the overflow brick, a fulcrum span of the arched curved surface is W. At fulcrums of two ends of the arched curved surface, the gravity G generates component forces g1 and g2 along an arch direction, and the clamped acting force F is also applied to each of the fulcrums. Force analysis is performed on the acting force F to generate the component forces f1 and f2. Directions of the component forces f1 along a tangential direction of the arched curved surface are opposite to directions of the component force of gravity g1 and the component force of g2, thereby suppressing the increase of the arched height H1 (also referred to as a bending degree) of the arched curved surface.

Therefore, the present disclosure provides an overflow brick for stably producing substrate glass, including the overflow brick body and support clamping devices 23.

The overflow brick body includes a first brick body 21 and a second brick body 22 sequentially from top to bottom. The first brick body 21 is provided with a concave overflow groove, an upper end surface of the concave overflow groove is an inclined surface, and the first brick body is configured to accommodate molten glass. The first brick body 21 is fixedly connected to the second brick body 22. The second brick body 22 has a V-shaped structure, and is configured to overflow and draw-down the molten glass. A fixed connection surface 212 between the first brick body 21 and the second brick body 22 is an arched curved surface 211.

Each of the support clamping devices 23 has an L-shaped structure. A horizontal section of each of the support clamping devices 23 is provided with a recessed groove adapted to the V-shaped structure, and the horizontal sections of the support clamping devices 23 are symmetrically arranged at two ends of the second brick body 22. Vertical sections of the support clamping devices 23 clamp two ends of the overflow brick body. An end surface of each of the vertical sections is higher than a highest horizontal cross-section of the arched curved surface 211 and lower than an inner groove bottom surface of the concave overflow groove. The vertical section of each of the support clamping devices 23 is configured to apply the acting force F to the overflow brick body.

The overflow brick refers to a structure body configured to carry and guide the molten glass, thereby achieving overflow and draw-down forming.

In some embodiments, a material of the overflow brick body includes a refractory material.

The refractory material may be any material system that is compatible with the molten glass, maintains an extremely low creep rate, and meets strength requirements under long-term high temperature.

In some embodiments, the refractory material includes an aluminosilicate material, an alkaline material, a carbon-containing material, a siliceous material, a silicon carbide-based material, a special material, or the like, or any combination thereof.

For example, the refractory material may be selected from one or more composite materials of a high-purity fireclay brick, a magnesia-chrome brick, a carbon brick, a silicon carbide (SiC) brick, or a special zircon brick.

The overflow brick body is made of the refractory material to ensure sufficient strength and stability in a high-temperature environment.

The overflow brick body has sufficient strength and stability in an extremely high-temperature environment, and no contamination or violent reaction occurs in a portion of the overflow brick body in contact with the molten glass, thereby ensuring the quality of subsequently produced substrate glass.

In some embodiments, the overflow brick may be an assembly formed by combining a plurality of modular components. For example, the overflow brick may be formed by connecting the first brick body and the second brick body from top to bottom.

The first brick body refers to an upper component of the overflow brick body, and the upper end surface of the first brick body is provided with the inclined concave overflow groove to accommodate and guide the molten glass.

The concave overflow groove refers to a concave morphology located on the upper end surface of the first brick body. In some embodiments of the present disclosure, the concave overflow groove may include a single continuous groove, a segmented groove, a combination of a plurality of mutually staggered grooves, or the like, or any combination thereof.

The second brick body refers to a lower component of the overflow brick body, and a cross-section of the second brick body forms a V-shaped or approximately V-shaped flow guiding structure for receiving and drawing down the molten glass along both sides of the second brick body to form a glass ribbon.

Overflowing and drawing down the molten glass refers to that the second brick body 22 guides the molten glass to flow uniformly on both sides of a surface of the second brick body 22, and the molten glass converges at the bottom of the second brick body 22 and finally achieves glass substrate forming (i.e., “overflow and draw-down”).

The V-shaped structure may be an ideally symmetrical straight wedge shape, or an approximately V-shaped cross-section composed of multiple planar or curved segments. In some embodiments, the V-shaped structure may be adapted to different processing accuracies or wear states through pads or replaceable force-bearing surfaces.

Two side surfaces of the V-shaped structure are flow guiding surfaces for drawing down the molten glass. For example, the two side surfaces of the V-shaped structure may be finely processed planes, or curved surfaces that are polished or coated with wear-resistant layers.

The arched curved surface refers to an upwardly convex curved surface of a fixed connection surface 212 between the first brick body and the second brick body. For example, the arched curved surface may be formed by an arc, a parabola, an elliptical arc, or any smooth free curve or surface.

In some embodiments, the arched curved surface may not be limited to a single mathematical curve. Any surface that forms an overall pre-arch (pre-camber) and achieves equivalent functions to the anti-creep or pre-deformation functions described below falls within the scope of the arched curved surface disclosed in the present disclosure.

As shown in FIG. 5, the arched height H1 refers to a vertical distance from a highest point of the arched curved surface 211 to a corresponding reference horizontal cross-section.

In some embodiments, the arched height H1 of the arched curved surface 211 is greater than a product of a relative creep rate \dot{ε} of the overflow brick, the fulcrum span W of the overflow brick, and the designed service time t of the overflow brick.

That is, H1>\dot{ε}×W×t.

As used herein, \dot{ε} represents a relative creep rate of the overflow brick, W represents the fulcrum span of the overflow brick, and t represents the designed service time of the overflow brick.

The creep refers to an irreversible time-dependent deformation of the overflow brick under long-term high-temperature loading. The creep is often represented by a displacement Δ with respect to a reference point, and determined using a displacement sensor.

The creep rate ε refers to a creep displacement rate of the refractory material of the overflow brick under a specific high temperature (e.g., 1300° C.) or stress state.

The relative creep rate \dot{ε} refers to a change rate in a relative length of the overflow brick per unit time. The relative creep rate \dot{ε} may be equal to (Δε/Δt) or (Δ/W t).

The creep rate and the relative creep rate may be obtained based on data measured by the displacement sensor through mathematical manners and linear fitting manners.

In some embodiments, the creep rate ε of the overflow brick is less than 10×10⁻⁵ mm/hr at 1300° C. In some embodiments, under an operating condition of 1300° C., the creep rate ε of the overflow brick is less than 9.5×10⁻⁵ mm/hr, 8×10⁻⁵ mm/hr.

In some embodiments, under the operating condition of 1300° C., the creep rate ε of the overflow brick is less than 5×10⁻⁵ mm/hr. For example, the creep rate ε of the overflow brick is less than 4.5×10⁻⁵ mm/hr, 3.2×10⁻⁵ mm/hr.

In some embodiments, under the operating condition of 1300° C., the creep rate ε of the overflow brick is less than 2×10⁻⁵ mm/hr. For example, the creep rate ε of the overflow brick is less than 1.8×10⁻⁵ mm/hr, 1.1×10⁻⁵ mm/hr.

In some embodiments, under the operating condition of 1300° C., the creep rate ε of the overflow brick is less than 1×10⁻⁵ mm/hr. For example, the creep rate ε of the overflow brick is less than 0.8×10⁻⁵ mm/hr, 0.3×10⁻⁵ mm/hr.

In some embodiments of the present disclosure, an upper limit of the creep rate is strictly defined to ensure that the material of the overflow brick body maintains dimensional stability under the action of long-term high-temperature and stress, thereby ensuring stable and high-precision production of the substrate glass.

The fulcrum span W refers to a horizontal distance between two endpoints where the overflow brick body is actually supported during a production process. The fulcrum span W is obtained by monitoring using a displacement sensor 25 in real time.

The designed service time refers to an expected time for which the overflow brick continuously operates under the high-temperature environment. The designed service time is determined by querying a preset table according to a product model of the overflow brick. The preset table includes product models of overflow bricks and corresponding designed service time of each of the product models of the overflow bricks.

In some embodiments of the present disclosure, the arched height H1 of the arched curved surface is accurately determined based on the creep rate, the fulcrum span, and the designed service time of the overflow brick. This configuration can counteract and delay a central subsidence caused by the high-temperature creep in the initial stage, thereby maintaining a midline profile of the concave overflow groove and reducing the impact of the creep on performance of the overflow brick during long-term use.

In some embodiments, the distance H2 from the arched curved surface 211 to the inner groove bottom surface 11 of the concave overflow groove is not less than 30 mm.

The inner groove bottom surface refers to a lower interface for flow of the molten glass. In some embodiments of the present disclosure, the inner groove bottom surface may be a single continuous flat bottom or a curved surface, and a slope of the inner groove bottom surface may be adjusted according to viscosity and flow rate requirements of the molten glass.

Merely by way of example, the vertical distance H2 between the highest point (or a horizontal cross-section of the highest point) of the arched curved surface 211 and the inner groove bottom surface (i.e., a lowest point where the molten glass is located) of the concave overflow groove is not less than 30 mm.

The 30 mm is a minimum thickness corresponding to the strength determined based on strength requirements of the refractory material at an operating temperature, thereby ensuring that the first brick body can withstand weight and thermal stress of the molten glass at this thickness, while reserving a buffer space to prevent excessively fast heat transfer.

In some embodiments, the distance H2 is within a range of 30 mm to 60 mm. The distance H2 may be any value larger than 30 mm, for example, 35 mm, 40 mm, 45 mm, 50 mm, 55 mm, etc. In some embodiments, the distance H2 is within a range of 30 mm to 100 mm. A specific value of the distance H2 may be determined based on strength and thermal operation conditions of the refractory material.

The minimum value of the distance H2 may be determined based on a type of the refractory material used, minimum allowable strength of the refractory material at the operating temperature, and weight of the molten glass borne by the first brick body. After the minimum value is determined by using the mathematical manners, the first brick body has sufficient mechanical strength and thermal shock resistance.

This configuration ensures that a portion of the first brick body above the arched curved surface has a sufficient material thickness, thereby providing sufficient mechanical strength and thermal stability, and preventing the first brick body from cracking or deforming too quickly under high temperature and heavy pressure.

The support clamping devices refer to a component configured to provide support at both ends of the overflow brick and horizontally apply a clamping acting force. The structure of each of the support clamping devices is an L-shaped structure. The L-shaped structure may be made of a bent metal member, a composite material, or a heat-resistant alloy.

The L-shaped structure of each of the support clamping devices only exemplarily indicates that the support clamping device has two functional parts: a bearing section (the horizontal section) and a vertical clamping section (the vertical section). Any equivalent structure (e.g., a clamping arm with a curvature, a segmented clamping member, a structure combined with an external clamping system, etc.) capable of providing bearing at both ends and horizontally applying the clamping acting force on an outer side is within the scope of the present invention.

In this embodiment, each of the support clamping devices has the L-shaped structure, including the horizontal section and the vertical section. The horizontal section is provided with the recessed groove adapted to the shape of the second brick body and serves as a mounting surface for the displacement sensor. The vertical section covers both ends of the overflow brick and applies the horizontal clamping force on the outer side through an actuator. The horizontal section and the vertical section may be formed by integral bending or mechanical connection. A connection therebetween is provided with a thermal expansion compensation structure and a replaceable refractory liner, thereby ensuring effective transmission of the clamping force, allowing for thermal deformation, and facilitating maintenance during long-term high-temperature operation. Any equivalent structure capable of achieving the aforementioned functions of supporting, positioning, and externally adjustable clamping is within the scope of the present disclosure.

The horizontal section of each of the support clamping devices is provided with the recessed groove adapted to the V-shaped structure of the second brick body to support or position the second brick body. For example, the recessed groove of the horizontal section may be a continuous groove or a segmented groove, and may be combined with the refractory liner to compensate for machining differences or wear.

In some embodiments, the positioning pin 24 is vertically disposed on the horizontal section of each of the support clamping devices 23, and the positioning pins 24 are configured to fixedly connect the first brick body 21 and the second brick body 22.

The positioning pins 24 are vertically disposed on the horizontal section of each of the support clamping devices 23 and passes through pin holes aligned between the first brick body 21 and the second brick body 22, to fixedly connecting the first brick body 21 and the second brick body 22 and ensure that connection surfaces 212 remain concentric and fitted under the thermal operation conditions.

The positioning pins 24 are distributed at a predetermined spacing, which is uniform or partitioned, based on force and thermal deformation characteristics around the connection surfaces 212. The positioning holes (the pin holes) are made as guide holes whose diameter is slightly larger than a pin diameter, and are combined with a high-temperature gap-filling material or a liner to accommodate thermal expansion.

A form of the positioning pin 24 is not limited to a solid pin, but also includes a hollow sleeve, an elastic high-temperature washer, or a combination of a removable bolt and a pin. The positioning pin 24 may be any connecting member or positioning structure that can ensure reliable connection, no misalignment, and a smooth and gapless connection surface between upper and lower parts of the overflow brick body. Any equivalent construction capable of achieving abutting, positioning, and force transmission functions under operation conditions is within the scope of the present disclosure.

In some embodiments, a material of the positioning pin 24 includes a refractory material, and the refractory material is the same as that used for the overflow brick body.

The material of the positioning pin may have a thermal expansion coefficient and a high-temperature creep resistance characteristic similar to those of the overflow brick body, thereby preventing loosening or cracking at the connection due to differences in thermal stress or the creep under a high-temperature operation condition.

In cases requiring higher strength or convenient assembly and disassembly, a high-temperature alloy or composite pin that can be protected by coatings may be used. The metal pin must adopt thermal insulation or coating measures to prevent chemical reactions or local erosion. The limitation of the refractory material of the positioning pin is a preferred embodiment, and does not exclude equivalent implementations using other high-temperature compatible materials.

The positioning pins also use the same refractory material as the overflow brick body to ensure the reliable connection, no misalignment, and the smooth and gapless connection surface between the upper and lower parts of the overflow brick body, thereby enhancing high-temperature resistance performance of the overall structure.

Using the positioning pins with appropriate arrangement and materials, the first brick body and the second brick body can maintain positioning and central alignment during the long-term high-temperature operation, and reduce interface misalignment and uneven stress, thereby reducing local stress concentration and maintaining geometric stability of the overflow groove.

In some embodiments, the horizontal section of each of the support clamping devices 23 is provided with a horizontal through-hole, the displacement sensor 25 is disposed inside the horizontal through-hole, and the displacement sensor 25 is configured to monitor a fulcrum span W of the overflow brick.

The displacement sensor 25 is disposed inside the horizontal through-hole of the horizontal section of each of the support clamping devices, and a probe of the displacement sensor 25 extends out and abuts against the overflow brick body.

The displacement sensor 25 is configured to measure and monitor the fulcrum span W of the overflow brick in real time and dynamically transmit the changes in the fulcrum span W caused by the creep.

The displacement sensor 25 may include a laser displacement meter, an eddy current sensor, etc., capable of performing precise displacement measurement in the high-temperature environment.

The fulcrum span W refers to the horizontal distance between the two endpoints where the overflow brick body is actually supported during the production process. In a structure using the support clamping device 23, W corresponds to an effective support length of the horizontal section of each of the support clamping devices.

A fluctuation range of the fulcrum span W refers to an allowable interval for a slight change of a W value relative to an initial design value or a target value of the W value, which is controlled by actively adjusting the acting force F, etc., during continuous production of the substrate glass by the overflow brick.

The fluctuation range of the fulcrum span is within a range of −0.5 mm to 0.5 mm. The fluctuation range is determined based on high-precision requirements for the thickness uniformity in the production of the high-generation substrate glass.

In some embodiments, the fluctuation range of the fulcrum span W is set such that creep deformation is within a controllable minimal range. The controllable minimal range may be adjusted between ±0.1 mm and ±1 mm according to the product generations and accuracy requirements.

In one or more embodiments of the present disclosure, by ensuring that the W value is maintained within the fluctuation range of ±0.5 mm, the creep is precisely controlled, thereby improving production stability and product quality.

The horizontal section of each of the support clamping devices includes the displacement sensor, which can monitor the fulcrum span W of the overflow brick in real time, thereby providing data support for timely adjustment of the acting force F and creep control, and making the monitoring and adjustment during the production process more convenient and accurate.

The vertical section of each of the support clamping devices is configured to apply a lateral clamping force (i.e., the acting force F) to the outer side of the overflow brick. More descriptions regard the generation and adjustment of the acting force F may be found in corresponding descriptions later.

A position of the end surface of the vertical section of each of the support clamping devices is defined as being above the horizontal cross-section of the highest point of the arched curved surface and below the inner groove bottom surface of the concave overflow groove. This relative height relationship ensures clamping the end surface that does not intrude into a glass flow area and effectively applies lateral constraint to the arched portion.

In some embodiments, the overflow brick body may be formed by assembling the upper first brick body and the lower second brick body via a mechanical positioning pin, a mortise and tenon, an adhesive, integral casting, etc. For example, the upper first brick body and the lower second brick body may also be connected by detachable bolts for on-site replacement and repair.

In some embodiments, the connection surface 212 of the first brick body and the second brick body is a preset arched curved surface, and the connection surface of the connection surface 212 should be smooth and free of steps to ensure continuity of a contact area and the force transmission. The two ends of the second brick body are horizontally supported by the horizontal section of each of the support clamping devices, and the horizontal sections of the support clamping devices are symmetrically arranged at the two ends of the second brick body. The recessed groove of the horizontal section matches the shape of the second brick body to achieve initial positioning and lateral constraint. The vertical sections of the support clamping devices cover and clamp the two ends of the overflow brick. The relative height of the end surface is located between the highest point of the arched curved surface and the inner groove bottom surface, to avoid direct interference with the flow of the molten glass, and ensure the lateral constraint on the arched connection surface.

The above implementations are merely preferred examples. Any shapes, connection manners, material selections, and tolerance ranges that can achieve the same or similar functions and effects without departing from the technical contributions of the present disclosure, such as using segmented clamping members instead of the continuous L-shaped structure, or using the integral casting instead of the assembly connection, should be regarded as equivalent implementations contained by the present disclosure.

The overflow brick for stably producing the substrate glass provided by the present disclosure adopts a split arched overflow brick structure. The overflow brick body is designed by connecting the first brick body and the second brick body, thereby weakening the influence of the overflow brick's own gravity on the production stability. Meanwhile, each of the support clamping devices with the L-shaped structure is introduced to counteract the negative effects of the creep by applying the clamping force horizontally. By designing the fixed connection surface of the first brick body and the second brick body as the arched curved surface, and combining with the clamping acting force provided by each of the support clamping devices, the overall structural stability of the overflow brick can be enhanced, and the overflow brick can inhibit the creep phenomenon that occurs in the production process of the high-generation substrate glass in the high-temperature and long-term operation environment, thereby effectively resisting deformation. The molten glass is overflowed and drawn down in a stable and uniform state, thereby improving the thickness uniformity of the overflow glass and the production quality of the substrate glass.

Based on the same inventive concept, the present disclosure provides the overflow apparatus for stably producing the substrate glass including the overflow brick. The overflow brick is the overflow brick for stably producing the substrate glass.

In some embodiments, a usage manner of the overflow brick for stably producing the substrate glass includes: first connecting the first brick body 21 with the concave overflow groove and the second brick body 22 having the V-shaped structure via the positioning pins 24 to assemble the overflow brick body; placing the two ends of the overflow brick body on the horizontal section of each of the support clamping devices 23 with the L-shaped structure, ensuring that the V-shaped structure of the second brick body 22 fits with the recessed groove of the horizontal section; ensuring that the displacement sensor 25 disposed inside the horizontal section of each of the support clamping devices 23 is in an operating state, for monitoring the fulcrum span W of the overflow brick in real time; applying the preset horizontal acting force F to the overflow brick body, the preset horizontal acting force F being transmitted to the two ends of the overflow brick body via the vertical section of each of the support clamping devices 23; ensuring that an application cross-section of the acting force F is located above the highest horizontal cross-section of the arched curved surface 211 and below the inner groove bottom surface of the concave overflow groove; during the high-temperature production process, using the displacement sensor 25 to monitor the fulcrum span W of the overflow brick in real time; in response to a change in the fulcrum span W, dynamically transmitting a change amount to the displacement sensor 25, and at this time, by adjusting the acting force F applied to the overflow brick body, the component forces f1 of the acting force along the tangential direction of the arched curved surface are opposite to the component force of gravity g1 and g2 of gravity of the overflow brick to form a cancellation relationship; by continuously adjusting the acting force F, ensuring that the fulcrum span W is maintained within a very small fluctuation range, such as, 0.5 mm.

In some embodiments, by actively adjusting the acting force F, the high-precision real-time control of the creep is achieved. This ensures that the overflow brick body still effectively resists deformation under long-term high-temperature and high-stress environments, and limit the dimensional changes caused by the creep to the very small tolerance range, thereby ensuring the uniformity of the molten glass overflow and significantly improving the production quality of the substrate glass.

Based on the same inventive concept, the present disclosure provides a method for stably producing the substrate glass using the overflow brick for stably producing the substrate glass. The method for stably producing the substrate glass using the overflow brick for stably producing the substrate glass includes applying the acting force F to the overflow brick body, and controlling the creep of the overflow brick by adjusting the acting force F.

The acting force F refers to the clamping acting force (which may also be referred to as “clamping force” in the present disclosure) applied to the two ends of the overflow brick body via each of the support clamping devices. In some embodiments, the acting force F is in a horizontal direction.

Controlling the creep of the overflow brick refers to actively applying and adjusting a magnitude of the acting force F to counteract or suppress the creep deformation of the overflow brick under the high-temperature and gravity, and maintaining the fulcrum span W of the overflow brick within a predetermined stable range.

In some embodiments, after the overflow brick body is assembled and put into the high-temperature operation environment, the preset acting force F is applied to the two ends of the overflow brick body via each of the support clamping devices (e.g., a hydraulic or mechanical clamp). During the production process, the magnitude of the acting force F is dynamically and continuously adjusted based on creep monitoring data (e.g., the change of the fulcrum span W). When the overflow brick body tends to deform downward due to the creep under the influence of gravity, the acting force F generates an upward force component through the arched connection surface, effectively counteracting part of the stress caused by the gravity or suppressing the change of the fulcrum span caused by the creep.

In some embodiments, to achieve fine control of the creep of the overflow brick, the acting force F applied to each of the support clamping devices should adopt a closed-loop fine-tuning strategy rather than blindly applying large step increases in force. In some embodiments, trend prediction (based on the creep rate of historical W(t)) is combined for feedforward compensation. Furthermore, when a sudden displacement change or abnormal contact pressure is detected, a controller may enter a protection mode and issue an alarm. Through small, frequent, and limited force adjustments, the above control strategy can suppress central sagging while avoiding accelerating material creep due to excessive local pressure.

In some embodiments, the acting force F horizontally is applied to the overflow brick body based on the vertical section of each of the support clamping devices.

The vertical section of each of the support clamping devices is a vertical plate portion of the L-shaped structure and is a main contact surface for applying the horizontal clamping force to the overflow brick body. More descriptions regarding the vertical section may be found in corresponding descriptions above.

In some embodiments, by pushing the vertical section of each of the support clamping devices 23, the horizontal acting force F is transmitted to outer sides of the two ends of the overflow brick body. The vertical section of each of the support clamping devices 23 for the L-shaped structure is in close contact with the outer side surface of the overflow brick body (particularly the second brick body 22). The horizontal clamping acting force F is applied by providing thrust through a hydraulic cylinder or screw mechanism located behind the vertical section. The height of the horizontal cross-section where the acting force F acts is defined as being above the highest point of the arched curved surface 211 and below the inner groove bottom surface of the concave overflow groove. The vertical section is selected to apply the horizontal force, thereby ensuring that the acting force F effectively generates the component force resisting the gravity along the tangential direction of the arched curved surface, and maximizing the anti-creep characteristics of the arched structure.

Manners of applying the horizontal acting force F may include mechanical clamping, hydraulic pushing, pneumatic loading, bolt pre-tightening, etc. The manners of applying the acting force F may be any manner that applies the horizontal clamping force to the overflow brick body through the structure of each of the support clamping devices to achieve the purpose of controlling the creep.

In one or more embodiments of the present disclosure, the accuracy of an height and direction of an application point of the clamping acting force F is ensured, which enables the clamping acting force F to form an effective balance or cancellation with an internal gravity component force of the overflow brick, thereby efficiently suppressing the creep.

In some embodiments, by adjusting the acting force F, the component forces f1 of the acting force along the tangential direction of the arched curved surface are opposite to the component forces of gravity g1 and g2 of the overflow brick.

The component force f1 refers to a horizontal component force generated along the tangential direction of the arched curved surface 211 when the acting force F acts on the arched curved surface 211.

The component force g1 and the component force g2 refer to component forces generated along the tangential direction of the arch by decomposing the gravity of the overflow brick body at the arched curved surface.

As shown in FIG. 7, the component force f1 generated by the acting force F may include two component forces f1 in different directions. Each component force f1 corresponds to the component of gravity g1 and the component of gravity g2, respectively. The component of gravity g1 and the component of gravity g2 point along the tangential direction toward a direction of the creep. By adjusting the acting force F, the component forces f1 generated along the tangential direction are opposite to the directions of the component of gravity g1 and the component of gravity g2, thereby counteracting the destructive effects of the component of gravity g1 and the component of gravity g2 on the arch. This inhibits an increase in a curvature (the arched height) H1 of the arch, ensures that a reverse component force f1 maintains a required balance relationship with the component of gravity g1 and the component of gravity g2, and dynamically maintains an initial geometric form of the overflow brick, thereby achieving precise control of the creep.

In one or more embodiments of the present disclosure, the precise mechanical counteracting effect utilizes the arch structure to convert the horizontal clamping force into an anti-gravity component force, thereby inhibiting the influence of the creep on the form of the overflow brick from a mechanical mechanism perspective, and improving the dimensional stability of the overflow brick during long-term operation.

In some embodiments, in response to the change in the fulcrum span, the change in the fulcrum span is dynamically transmitted to the displacement sensor (e.g., the displacement sensor 25), and the fluctuation range of the fulcrum span W is controlled within −0.5 mm to 0.5 mm by adjusting the acting force.

More descriptions regarding the fulcrum span W, the displacement sensor, the acting force F, and the fluctuation range of the fulcrum span W may be found in corresponding descriptions above.

In some embodiments, the displacement sensor monitors the fulcrum span W in real time. Once a minor change in the fulcrum span W occurs due to the creep (e.g., an increase), the displacement sensor sends a signal to a control system. An adjustment amount for the required acting force F is determined based on the fulcrum span W, and an instruction is sent to a clamping mechanism based on the adjustment amount. The clamping mechanism adjusts the acting force F, causing the fulcrum span W to return to a stable range.

In some implementations, the displacement sensor is an eddy current displacement sensor installed within the horizontal through-hole of the horizontal section of each of the support clamping devices. The displacement sensor measures a point distance between support points at two ends via a thermal-insulation extension piece. A sampling frequency of the displacement sensor is preferably greater than Hz. A sensing signal is filtered and then determined by the controller to drive the actuator. A target control maintains the dynamic fluctuation of W within ±0.5 mm. A sampling and control response time may be adjusted within a range of 0.5s to 5s according to the operating conditions.

In some embodiments, manners for controlling the creep may be any closed-loop control strategy that monitors changes in key dimensions of the overflow brick in real time or quasi-real time and dynamically adjusts the magnitude of the clamping acting force F to maintain the form stability of the overflow brick.

In one or more embodiments of the present disclosure, the high-precision real-time control of the creep of the overflow brick is achieved, so that deformation caused by the creep is limited to an extremely small range (within ±0.5 mm). This greatly improves the stability and repeatability of the production process, and is a key guarantee for the preparation of ultra-large-sized and high-uniformity substrate glass.

In one or more embodiments of the present disclosure, by actively adjusting the acting force F to control the creep, irreversible and uncontrollable defects of traditional overflow brick creep are overcome. Dynamic maintenance of the geometric shape and dimension of the overflow brick is achieved, thereby ensuring that the molten glass is overflowed and drawn down in the stable and uniform state, and improving the production stability and the product quality.

In some embodiments, applying the acting force F to the overflow brick body is not limited to a single mechanical means. Any technique capable of providing the controllable horizontal constraint at the end or the outer side and influencing the arch stress distribution and creep accumulation by adjusting the constraint is considered an equivalent implementation, including but not limited to: mechanical clamping (lead screw or clamping plate), hydraulic or pneumatic clamping, servo motor-driven screw thrust, a controllable pre-strain beam, or a thermal deformation device (which indirectly adjusts the stress distribution by locally heating or cooling to change a support state).

In some embodiments, the sensing manner is also not limited to a specific type. Optical ranging, laser displacement, visual recognition, distributed optical fiber sensing, etc., may replace traditional contact sensing. The control strategy may adopt a centralized or distributed controller, manual semi-closed-loop control, or fully automatic closed-loop control.

In some embodiments, regarding the mapping of mechanical parameters, although the present disclosure uses Δ=\dot{ε}W t as a design reference, more complex creep models (e.g., Norton or a three-stage creep model) may be used for conversion under specific materials and accelerated test conditions. The manner is not limited to a specific mathematical model. Any equivalent variation that does not depart from the basic technical idea of the present disclosure, which controls the creep of the overflow brick by applying an externally adjustable constraint force, is within the scope of the present disclosure.

As an embodiment of the present disclosure, referring to FIG. 1 and FIG. 5, the overflow brick body is divided into the upper first brick body 21 and the lower second brick body 22. The first brick body 21 includes the concave overflow groove, the upper end surface of the concave overflow groove is an inclined surface, and the first brick body is configured to accommodate molten glass. The second brick body 22 has the V-shaped structure, and is configured to overflow and draw-down the molten glass. The fixed connection surface between the first brick body 21 and the second brick body 22 is the arched curved surface 211. The upper part and the lower part are connected as one body via the positioning pins 24. Two ends are provided with one of the support clamping devices 23, which apply the clamping acting force F horizontally to the overflow brick body, ensuring that the clamping mechanism and the overflow brick are in close contact without gaps.

Each of the support clamping devices 23 has the L-shaped structure. The entire second brick body 22 is placed on the horizontal section of each of the support clamping devices 23. The vertical section covers the connection surface between the second brick body 22 and each of the support clamping devices 23. Specifically, the end surface of the vertical section is higher than the highest horizontal cross-section of the arched curved surface 211. Simultaneously, the end surface of the vertical section is lower than the inner groove bottom surface of the concave overflow groove. The clamping acting force F is horizontally applied to the outer side of the L-shaped (support) structure.

Simultaneously, the horizontal section of each of the support clamping devices 23 is disposed with a horizontal through-hole. The displacement sensor 25 is disposed inside the horizontal through-hole, configured to monitor the fulcrum span W of the overflow brick and instantly reflect the changes in the creep amount of the overflow brick. By adjusting the magnitude of F, the occurrence of the creep of the overflow brick is controlled. Benefiting from the unique arched curved surface structure, the component forces f1 and f2 generated by the acting force F are opposite to directions of the components of gravity g1 and g2 (referring to FIG. 7). Therefore, in some embodiments, increasing the acting force F may generate an upward resisting bending moment. However, in a traditional flat structure, harmful compressive stress might be primarily generated. During the high-temperature production process, the displacement sensor 25 is monitored in real time. When the creep occurs, the fulcrum span W changes and is dynamically reflected by the displacement sensor. At this time, by increasing the acting force F, the fulcrum span W is maintained within the very small fluctuation range, generally ±0.5 mm. In this state, it is ensured that the creep of the overflow brick does not undergo large fluctuations, thereby enabling the overflow brick to inhibit the creep phenomenon during the production of the high-generation substrate glass in the high-temperature and long-term operation environment and effectively resist the deformation. This ensures that the molten glass is overflowed and drawn down in the stable and uniform state, thereby improving the thickness uniformity of the overflow glass and the production quality of the substrate glass.

Finally, it should be noted that the embodiments listed above are merely one or more specific manifestations of the technical solution of the present disclosure. Their purpose is to clearly explain the concept, principle, and application method of the present disclosure through specific examples, and are by no means intended to limit the protection scope of the present disclosure to these specific embodiments. In fact, the true value of the present disclosure lies in the technical ideas and innovation points it proposes, rather than its manifestation form or implementation means.

For those of ordinary skill in the art, after thoroughly reading and understanding the technical solution of the present disclosure, they are fully capable of making various changes, modifications, or equivalent replacements to the specific implementation modes of the invention based on their own professional knowledge and skills. These changes may include, but are not limited to, adjusting the value range of technical parameters, optimizing algorithm processes to improve efficiency, replacing some technical components to achieve better compatibility or reduce costs, etc. As long as these changed technical solutions substantially retain the technical features claimed by the original invention, i.e., they may still achieve the core functions and effects of the present disclosure, then these changes should be considered as falling within the protection scope of the claims to be approved of the present disclosure.

Furthermore, with the continuous progress and development of technology, new technical means and manners are constantly emerging, which also provides a broad space for further improvement and perfection of the present disclosure. Therefore, the protection scope of the present disclosure should also include reasonable foreseeable improvements and extensions based on existing technology. As long as these improvements and extensions do not depart from the basic principles and core concepts of the present disclosure, they should be regarded as equivalents of the present disclosure and equally protected by patent rights.

What is claimed is:

1. An overflow brick for stably producing substrate glass, comprising:
an overflow brick body; and
support clamping devices, wherein
the overflow brick body includes a first brick body and a second brick body sequentially from top to bottom;
the first brick body is provided with a concave overflow groove, an upper end surface of the concave overflow groove is an inclined surface, and the first brick body is configured to accommodate molten glass;
the first brick body is fixedly connected to the second brick body;
the second brick body has a V-shaped structure, and is configured to overflow and draw-down the molten glass;
a fixed connection surface between the first brick body and the second brick body is an arched curved surface;
each of the support clamping devices has an L-shaped structure;
a horizontal section of each of the support clamping devices is provided with a recessed groove adapted to the V-shaped structure, and the horizontal sections of the support clamping devices are symmetrically arranged at two ends of the second brick body;
vertical sections of the support clamping devices clamp two ends of the overflow brick body; and
an end surface of each of the vertical sections is higher than a highest horizontal cross-section of the arched curved surface and lower than an inner groove bottom surface of the concave overflow groove.

2. The overflow brick of claim 1, wherein an arched height of the arched curved surface is greater than a product of a relative creep rate of the overflow brick, a fulcrum span of the overflow brick, and a designed service time of the overflow brick.

3. The overflow brick of claim 2, wherein a creep rate of the overflow brick is less than 10×10⁻⁵ mm/hr at 1300° C.

4. The overflow brick of claim 1, wherein a distance from the arched curved surface to the inner groove bottom surface is not less than 30 mm.

5. The overflow brick of claim 1, wherein a material of the overflow brick body comprises a refractory material.

6. The overflow brick of claim 5, wherein the refractory material includes at least one of an aluminosilicate material, an alkaline material, a carbon-containing material, a siliceous material, a silicon carbide-based material, or a special material.

7. The overflow brick of claim 1, wherein a positioning pin is vertically disposed on the horizontal section of each of the support clamping devices, and the positioning pin is configured to fixedly connect the first brick body and the second brick body.

8. The overflow brick of claim 7, wherein a material of the positioning pin comprises a refractory material.

9. The overflow brick of claim 1, wherein the horizontal section of each of the support clamping devices is provided with a horizontal through-hole, a displacement sensor is disposed inside the horizontal through-hole, and the displacement sensor is configured to monitor a fulcrum span of the overflow brick.

10. The overflow brick of claim 9, wherein a fluctuation range of the fulcrum span is within −0.5 mm to 0.5 mm.

11. An overflow apparatus for stably producing substrate glass, comprising:
the overflow brick according to claim 1.

12. A method for stably producing substrate glass using the overflow brick for stably producing the substrate glass according to claim 1, comprising:
applying an acting force to the overflow brick body; and
controlling creep of the overflow brick by adjusting the acting force.

13. The method of claim 12, wherein the applying an acting force to the overflow brick body includes:
applying, based on the vertical section of each of the support clamping devices, the acting force horizontally to the overflow brick body.

14. The method of claim 12, wherein the controlling a creep of the overflow brick by adjusting the acting force includes:
adjusting the acting force such that a component force of the acting force along a tangential direction of the arched curved surface is opposite to a component force of gravity of the overflow brick.

15. The method of claim 12, wherein the controlling a creep of the overflow brick by adjusting the acting force includes:
in response to a change in the fulcrum span, dynamically transmitting the change in the fulcrum span to the displacement sensor; and
controlling a fluctuation range of the fulcrum span within −0.5 mm to 0.5 mm by adjusting the acting force.
